(19) United States
(12) Patent Application Publication
(10) Pub. No.: US 2025/0154817 A1
(43) Pub. Date: May 15, 2025

(54) VEHICLE CONTROL APPARATUS AND METHOD THEREOF

(71) Applicants: HYUNDAI MOTOR COMPANY, Seoul (KR); KIA CORPORATION, Seoul (KR)

(72) Inventors: Bon Hyeok Ku, Siheung-si (KR); Chang Seob Park, Seoul (KR); Jae Young Park, Hwaseong-si (KR)

(73) Assignees: HYUNDAI MOTOR COMPANY, Seoul (KR); KIA CORPORATION, Seoul (KR)

(21) Appl. No.: 18/608,562

(22) Filed: Mar. 18, 2024

(30) Foreign Application Priority Data
Nov. 9, 2023 (KR) 10-2023-0154830

(51) Int. Cl. E05F 15/70; E05B 81/04; E05B 81/20; E05B 81/56; E05B 81/72; E05B 83/16

(52) U.S. Cl. CPC E05F 15/70; E05B 81/04; E05B 81/20; E05B 81/56; E05B 81/72; E05B 83/16; E05Y 2400/50; E05Y 2900/546

(57) ABSTRACT

A vehicle control apparatus includes an input device, a sensor device, a memory, and a controller. For example, the vehicle control apparatus receives a user input about an opening operation or a closing operation for a tailgate through the input device. The vehicle control apparatus performs tailgate control corresponding to the user input based on an amount of target control. The vehicle control apparatus calculates a compensation value based on at least one of an amount of change in RPM identified using the sensor device in the tailgate control process, latch data, or any combination thereof, when it is determined that a first problem about the opening operation or a second problem about the closing operation occurs. The vehicle control apparatus reflects the compensation value into the amount of target control.

### CROSS-REFERENCE TO RELATED APPLICATION

This application claims the benefit of and the priority to Korean Patent Application No. 10-2023-0154830, filed in the Korean Intellectual Property Office on Nov. 9, 2023, the entire contents of which are incorporated herein by reference.

### TECHNICAL FIELD

The present disclosure relates to a vehicle control apparatus and a method thereof and more particularly relates to technologies for controlling the opening and closing of a tailgate of a host vehicle.

### BACKGROUND

The statements in this section merely provide background information related to the present disclosure and do not necessarily constitute prior art.

A vehicle may include various doors. For example, a space (e.g., a trunk), which is open to generally load luggage or objects, may be provided in the rear of the vehicle, and a door (e.g., a tailgate) corresponding to the space may be provided.

A trunk was used in the past in a manner in which a person directly opens and closes the tailgate. However, with the development of technology and the generation of various needs, a technology for opening and closing the tailgate in a fully automatic scheme has become more and more widespread.

Meanwhile, in the process of opening and closing the tailgate in the fully automatic scheme, an error may occur in an operation parameter (e.g., an opening and closing speed or a revolutions per minute (RPM)), a problem due to a characteristic of a component (e.g., a rubber part) for opening and closing may occur, or a problem in which the durability of the component is reduced or a reaction force is different from a target due to an ambient temperature may occur.

For example, there may occur a problem in which a relatively large reaction force occurs at the beginning of the opening operation in the process of controlling the opening operation for the tailgate. In this case, as an RPM for a tailgate opening operation drops momentarily, an RPM inflection may occur. Thus, because a user feels that the tailgate is not open uniformly but is temporarily stopped. This may cause inconvenience.

For example, although the lock operation should be performed while the latch is cinched at the end of the closing operation in the process of controlling the closing operation for the tailgate, as a relatively small reaction force occurs, there may occur a problem in which the cinching is not performed. In this case, as a user feels that a failure occurs in the tailgate operation, this may cause inconvenience.

### SUMMARY

The present disclosure has been made to solve the above-mentioned problems occurring in the prior art while advantages achieved by the prior art are maintained intact.

An aspect of the present disclosure provides a vehicle control apparatus for identifying a problem, which occurs during an opening operation or a closing operation for a tailgate, when receiving a user input to open or close the tailgate from a user. The vehicle control apparatus also calculates a compensation value based on pieces of data identified during the operation when it is identified that the problem occurs. The vehicle control apparatus also reflects the calculated compensation value into an amount of target control to control an opening and closing operation using the amount of updated target control when the user input is received again later.

Another aspect of the present disclosure provides a vehicle control apparatus for calculating an opening compensation value based on at least one of a time point when an inflection has occurred is before a specified time point, a predetermined maximum opening compensation value, a revolutions per minute (RPM) magnitude in the inflection, or any combination thereof, when identifying that the inflection of the RPM occurs at a specified magnitude or more as a relatively large reaction force occurs at the beginning of a tailgate opening operation, after controlling the tailgate opening operation.

Another aspect of the present disclosure provides a vehicle control apparatus for calculating a closing compensation value based on at least one of a first time point when a first switch included in a latch controller is turned on, a second time point when a second switch is turned on, a predetermined maximum closing compensation value, a compensation constant, or any combination thereof, when identifying that the cinching operation of the latch is not performed as a relatively small reaction force occurs at the end of a tailgate closing operation, after controlling the tailgate closing operation.

The technical problems to be solved by the present disclosure are not limited to the aforementioned problems. Any other technical problems not mentioned herein should be clearly understood from the following description by those having ordinary skill in the art to which the present disclosure pertains.

According to an aspect of the present disclosure, a driving control apparatus may include an input device, a sensor device, a memory configured to store at least one instruction, and a controller operatively connected with the input device, the sensor device, and the memory. For example, when executing the at least one instruction, the controller may be configured to receive a user input about an opening operation or a closing operation for a tailgate through the input device. The controller may be also configured to perform tailgate control corresponding to the user input based on an amount of target control. The controller may be also configured to calculate a compensation value based on at least one of an amount of change in RPM identified using the sensor device in a tailgate control process, latch data, or any combination thereof, when it is determined that a first problem about the opening operation or a second problem about the closing operation occurs. The controller may be also configured to reflect the compensation value into the amount of target control.

According to an embodiment, when executing the at least one instruction, the controller may also be configured to identify the amount of change in RPM during the opening operation using the sensor device, when the tailgate control corresponding to the user input is the opening operation. The controller may also be configured to determine that the first problem has occurred when identifying an inflection indicating that the RPM decreases and then increases, based on the amount of change in RPM. The controller may also be configured to identify an opening compensation value based on at least one of an RPM magnitude in the inflection, a time point when the inflection has occurred, a predetermined maximum opening compensation value, or any combination. The controller may also be configured to reflect the opening compensation value into the amount of target control.

According to an embodiment, when executing the at least one instruction, the controller may also be configured to identify the RPM magnitude in the inflection as the opening compensation value, when the time point when the inflection has occurred is before a specified time point.

According to an embodiment, when executing the at least one instruction, the controller may also be configured to identify the predetermined maximum opening compensation value as the opening compensation value, when the time point when the inflection has occurred is after a specified time point.

According to an embodiment, when executing the at least one instruction, the controller may also be configured to, when the user input corresponding to the opening operation for the tailgate is received again, perform the opening operation based on the amount of target control to which the opening compensation value has been applied. The controller may also be configured to identify the opening compensation value as the predetermined maximum opening compensation value or less. The controller may also be configured to reflect the opening compensation value into the amount of target control, when it is determined that the first problem has occurred.

According to an embodiment, the vehicle control apparatus may further include a latch controller. For example, when executing the at least one instruction, the controller may also be configured to identify a latch motor operation signal during the closing operation by means of the latch controller, when the tailgate control corresponding to the user input is the closing operation. The controller may also be configured to determine that the second problem has occurred, when identifying cinching of a latch is not performed during the closing operation, based on the latch motor operation signal. The controller may also be configured to identify a closing compensation value based on at least one of a first time point when a first switch included in the latch controller is turned on, a second time point when a second switch is turned on, a predetermined maximum closing compensation value, a compensation constant, or any combination. The controller may also be configured to reflect the closing compensation value into the amount of target control.

According to an embodiment, when executing the at least one instruction, the controller may also be configured to identify a smaller value between a first value identified using a difference between the first time point and the second time point and the compensation constant and the predetermined maximum closing compensation value as the closing compensation value, when the difference between the first time point and the second time point is less than or equal to a specified time.

According to an embodiment, when executing the at least one instruction, the controller may also be configured to not reflect the closing compensation value into the amount of target control, when a difference between the first time point and the second time point is greater than a specified time.

According to an embodiment, when executing the at least one instruction, the controller may also be configured to, when the user input corresponding to the closing operation for the tailgate is received again, perform the closing operation based on the amount of target control into which the closing compensation value has been reflected. The controller may also be configured to identify the closing compensation value as the predetermined maximum closing compensation value or less and reflect the closing compensation value into the amount of target control, when it is determined that the second problem has occurred while performing the closing operation.

According to an embodiment, when executing the at least one instruction, the controller may also be configured to calculate an opening compensation value in the compensation value. When the first problem has occurred, the controller may also be configured to add the opening compensation value to an opening control parameter in the amount of target control. When the second problem has occurred, the controller may also be configured to calculate a closing compensation value in the compensation value and subtract the closing compensation value from a closing control parameter in the amount of target control.

According to another aspect of the present disclosure, a driving control method may include receiving, by a controller, a user input about an opening operation or a closing operation for a tailgate through an input device. The driving control method may also include performing, by the controller, tailgate control corresponding to the user input based on an amount of target control. The driving control method may also include calculating, by the controller, a compensation value based on at least one of an amount of change in revolutions per minute (RPM) identified using a sensor device in a tailgate control process or latch data, or any combination thereof, when it is determined that a first problem about the opening operation or a second problem about the closing operation occurs. The driving control method may also include reflecting, by the controller, the compensation value into the amount of target control.

According to an embodiment, the vehicle control method may further include identifying, by the controller, the amount of change in RPM during the opening operation using the sensor device, when the tailgate control corresponding to the user input is the opening operation. The vehicle control method may further include determining, by the controller, the first problem has occurred when identifying an inflection indicating that an RPM decreases and then increases, based on the amount of change in RPM. The vehicle control method may further include identifying, by the controller, an opening compensation value based on at least one of an RPM magnitude in the inflection, a time point when the inflection has occurred, a predetermined maximum opening compensation value, or any combination. The vehicle control method may further include reflecting, by the controller, the opening compensation value into the amount of target control.

According to an embodiment, the vehicle control method may further include identifying, by the controller, the RPM magnitude in the inflection as the opening compensation value, when the time point when the inflection has occurred is before a specified time point.

According to an embodiment, the vehicle control method may further include identifying, by the controller, the predetermined maximum opening compensation value as the opening compensation value, when the time point when the inflection has occurred is after a specified time point.

According to an embodiment, the vehicle control method may further include performing, by the controller, when the user input corresponding to the opening operation for the tailgate is received again, the opening operation based on the amount of target control to which the opening compensation value has been applied. The vehicle control method may further include identifying, by the controller, the opening compensation value as the predetermined maximum opening compensation value or less and reflect the opening compensation value into the amount of target control, when it is determined that the first problem has occurred.

According to an embodiment, the vehicle control method may further include identifying, by the controller, a latch motor operation signal during the closing operation by means of a latch controller, when the tailgate control corresponding to the user input is the closing operation. The vehicle control method may further include determining, by the controller, that the second problem has occurred, when identifying cinching of a latch is not performed during the closing operation, based on the latch motor operation signal. The vehicle control method may further include identifying, by the controller, a closing compensation value based on at least one of a first time point when a first switch included in the latch controller is turned on, a second time point when a second switch is turned on, a predetermined maximum closing compensation value, a compensation constant, or any combination. The vehicle control method may further include reflecting, by the controller, the closing compensation value into the amount of target control.

According to an embodiment, the vehicle control method may further include identifying, by the controller, a smaller value between a first value identified using a difference between the first time point and the second time point and the compensation constant and the predetermined maximum closing compensation value as the closing compensation value, when the difference between the first time point and the second time point is less than or equal to a specified time.

According to an embodiment, the vehicle control method may further include not reflecting the closing compensation value into the amount of target control, when a difference between the first time point and the second time point is greater than a specified time.

According to an embodiment, the vehicle control method may further include performing, by the controller, when the user input corresponding to the closing operation for the tailgate is received again, the closing operation based on the amount of target control into which the closing compensation value has been reflected. The vehicle control method may further include identifying, by the controller, the closing compensation value as the predetermined maximum closing compensation value or less and reflecting, by the controller, the closing compensation value into the amount of target control, when it is determined that the second problem has occurred while performing the closing operation.

According to an embodiment, the vehicle control method may further include, when the first problem has occurred, calculating, by the controller, an opening compensation value in the compensation value and adding, by the controller, the opening compensation value to an opening control parameter in the amount of target control. The vehicle control method may further include, when the second problem has occurred, calculating, by the controller, a closing compensation value in the compensation value and subtracting, by the controller, the closing compensation value from a closing control parameter in the amount of target control.

### BRIEF DESCRIPTION OF THE DRAWINGS

The above and other objects, features, and advantages of the present disclosure should be more apparent from the following detailed description taken in conjunction with the accompanying drawings:

FIG. 1 is a block diagram illustrating components of a vehicle control apparatus according to an embodiment of the present disclosure;

FIG. 2 is a conceptual diagram illustrating components and an operation of a vehicle control apparatus according to an embodiment of the present disclosure;

FIG. 3 is a conceptual diagram illustrating a host vehicle and a tailgate according to an embodiment of the present disclosure;

FIG. 4A is an operational conceptual diagram of a vehicle control method for controlling a tailgate opening operation according to an embodiment of the present disclosure;

FIG. 4B is an operational conceptual diagram of a vehicle control method for controlling a tailgate opening operation according to an embodiment of the present disclosure;

FIG. 5A is an operational conceptual diagram of a vehicle control method for controlling a tailgate closing operation according to an embodiment of the present disclosure;

FIG. 5B is an operational conceptual diagram of a vehicle control method for controlling a tailgate closing operation according to an embodiment of the present disclosure;

FIG. 6 is a flowchart of a vehicle control method according to an embodiment of the present disclosure;

FIG. 7 is a flowchart of a vehicle control method according to an embodiment of the present disclosure;

FIG. 8 is a flowchart of a vehicle control method according to an embodiment of the present disclosure; and

FIG. 9 illustrates a computing system about a vehicle control apparatus or a vehicle control method according to an embodiment of the present disclosure.

With regard to description of drawings, the same or similar denotations may be used for the same or similar components.

### DETAILED DESCRIPTION

Hereinafter, some embodiments of the present disclosure are described in detail with reference to the drawings. In adding the reference numerals to the components of each drawing, it should be noted that the identical or equivalent components are designated by the identical numerals even when the components are displayed on other drawings. In addition, a detailed description of well-known features or functions has been omitted in order not to unnecessarily obscure the gist of the present disclosure.

In describing the components of the embodiment according to the present disclosure, terms such as first, second, “A”, “B”, (a), (b), and the like may be used. These terms are only used to distinguish one element from another element. These terms do not limit the corresponding elements irrespective of the order or priority of the corresponding elements. Furthermore, unless otherwise defined, all terms including technical and scientific terms used herein have the same meaning as being generally understood by those having ordinary skill in the art to which the present disclosure pertains. Such terms as those defined in a generally used dictionary should be interpreted as having meanings equal to the contextual meanings in the relevant field of art. Such terms should not be interpreted as having ideal or excessively formal meanings unless clearly defined as having such in the present disclosure. When a component, device, element, or the like of the present disclosure is described as having a purpose or performing an operation, function, or the like, the component, device, element, or the like should be considered herein as being “configured to” meet that purpose or to perform that operation or function. Each of the component, device, element, and the like may separately embody or be included with a processor and a memory, such as a non-transitory computer readable media, as part of the apparatus.

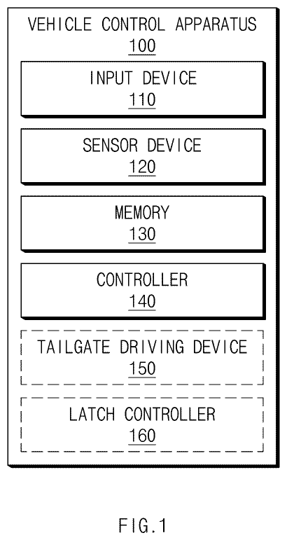

Hereinafter, embodiments of the present disclosure are described in detail with reference to FIGS. 1-9.

FIG. 1 is a block diagram illustrating components of a vehicle control apparatus according to an embodiment of the present disclosure.

According to an embodiment, a vehicle control apparatus 100 may include at least one of an input device 110, a sensor device 120, a memory 130, a controller 140, a tailgate driving device 150, a latch controller 160, or any combination thereof. The components of the vehicle control apparatus 100, which are shown in FIG. 1, are illustrative, and embodiments of the present disclosure are not limited thereto. For example, the vehicle control apparatus 100 may further include components (e.g., at least one of an interface, a display, a notification device, or a communication device, or any combination thereof), which are not shown in FIG. 1.

According to an embodiment, the input device 110 may include at least one input device (e.g., a button and/or a touch screen) configured to receive a control command for controlling opening and closing of a tailgate from a user.

For example, the input device 110 may receive a tailgate opening and closing control input (e.g., a pressure input and/or a touch input) to the at least one input device from the user. For example, when a command to open and close the tailgate for the input device 110 is received, the controller 140 may identify an intention of the user who wants to open or close the tailgate based on a type of the received input and/or a real-time tailgate opening and closing degree (e.g., opening angle information).

For example, the input device 110 may be provided in at least one area in the interior of a host vehicle. The input device 110 may be disposed in one area of at least one of, for example, a center fascia, a steering wheel, a tailgate, a front seat, or a rear seat, or any combination thereof.

For example, the input device 110 may be implemented as one device and may be implemented as two or more devices. For example, when a user input to the input device 110 is received, the controller 140 may identify whether an operation type corresponding to the user input is a tailgate opening operation or a tailgate closing operation.

According to an embodiment, the sensor device 120 may obtain (or identify) various pieces of information about a state of the host vehicle.

For example, the sensor device 120 may include at least one sensor including at least one of a camera, radio detection and ranging (RADAR), light detection and ranging (LiDAR), or any combination thereof.

For example, the sensor device 120 may include at least one sensor (e.g., a hall sensor) configured to obtain information about operation states of components (e.g., a tailgate) of the host vehicle.

As an example, the sensor device 120 may include at least one hall sensor, which is disposed on one area of the interior (e.g., one area of the tailgate) of the host vehicle, to obtain (or identify) state information about an opening angle degree of the tailgate, whether the tailgate moves, and/or a movement direction of the tailgate.

According to an embodiment, the memory 130 may store a command or data. For example, the memory 130 may store one or more instructions, when executed by the controller 140, causing the vehicle control apparatus 100 to perform various operations.

For example, the memory 130 and the controller 140 may be implemented as one chipset. The controller 140 may include at least one of a communication processor or a modem.

For example, the memory 130 may store various pieces of information associated with the vehicle control apparatus 100. As an example, the memory 130 may store information about an operation history of the controller 140. As an example, the memory 130 store information associated with states and/or operations of components (e.g., at least one of an engine control unit (ECU), the input device 110, the sensor device 120, the controller 140, the tailgate driving device 150, the latch controller 160, or any combination thereof) of the host vehicle.

For example, the memory 130 may store training data about a (revolutions per minute) RPM and current data according to an opening and closing state of the tailgate. In other words, the memory 130 may store the training data (e.g., a mapping table) about the RPM and the current data corresponding to an opening and closing degree (or an opening degree) of the tailgate.

For example, the memory 130 may store an amount of target control for controlling opening and closing of the tailgate. In other words, when the user input is received, the memory 130 may store an amount of control (e.g., an RPM) according to a time required to perform an operation (e.g., an opening operation or a closing operation) of a type corresponding to the user input.

As an example, the amount of target control may include a mapping table defined as a developer inputs predefined parameters in the stage of developing the vehicle control apparatus 100. At least some of the pieces of data included in the amount of target control may be changed by settings of a user and/or the developer. Furthermore, the at least some of the pieces of data included in the amount of target control may be repeatedly updated by reflecting a compensation value calculated by the vehicle control apparatus 100.

According to an embodiment, the controller 140 may be operatively connected to at least one of the input device 110, the sensor device 120, the memory 130, the tailgate driving device 150, the latch controller 160, or any combination thereof. For example, the controller 140 may control an operation of at least one of the input device 110, the sensor device 120, the memory 130, the tailgate driving device 150, the latch controller 160, or any combination thereof.

For example, the controller 140 may receive a user input about an opening operation or a closing operation for the tailgate through the input device 110.

As an example, when receiving the user input from the user through the input device 110 disposed in one area in the host vehicle, the controller 140 may identify whether the user input corresponds to any type of tailgate control (e.g., the opening operation or the closing operation).

For example, the controller 140 may perform tailgate control corresponding to the user input based on the amount of target control.

As an example, when the user input corresponds to the opening operation for the tailgate, the controller 140 may identify an amount of target control about the opening operation and may open the tailgate based on the amount of identified target control.

As an example, when the user input corresponds to the closing operation for the tailgate, the controller 140 may identify an amount of target control about the closing operation and may close the tailgate based on the amount of identified target control.

For example, when it is determined that a first problem about the opening operation or a second problem about the closing operation occurs, the controller 140 may calculate a compensation value based on at least one of an amount of change in RPM identified using the sensor device 120 in the tailgate control process, latch data, or any combination thereof.

When the tailgate control corresponding to the user input is the opening operation, the controller 140 may identify an amount of change in RPM during the opening operation using the sensor device 120. The amount of change in RPM may be a change in RPM according to a time used while the controller 140 controls the opening operation for the tailgate using the tailgate driving device 150 (or the motor).

As an example, when identifying an inflection indicating that the RPM decreases and then increases, based on the amount of change in RPM, the controller 140 may determine that the first problem has occurred. For example, when the RPM decreases by a specified first decrease amount and then increases by a specified first increase amount, the controller 140 may identify that the inflection has occurred and may determine that the first problem has occurred.

As an example, the controller 140 may identify an opening compensation value based on at least one of an RPM magnitude in the inflection, a time point when the inflection has occurred, a predetermined maximum opening compensation value, or any combination thereof. For example, when the time point when the inflection has occurred is before a specified time point, the controller 140 may identify the RPM magnitude in the inflection as the opening compensation value. For example, when the time point when the inflection has occurred is after the specified time point, the controller 140 may identify the predetermined maximum opening compensation value (e.g., 1000 rpm) as the opening compensation value. The specified time point may be defined as, for example, a time point when a specific time (e.g., 1000 ms) elapses from a time point when the opening operation starts. For example, after reflecting the opening compensation value into the amount of target control, when the user input corresponding to the opening operation is received again, the controller 140 may perform the opening operation based on the amount of target control into which the opening compensation value is reflected. At this time, when it is determined that the first problem has occurred again, the controller 140 may calculate an opening compensation value again in the above-mentioned manner. At this time, the controller 140 may identify the opening compensation value as the predetermined maximum opening compensation value or less and may reflect the opening compensation value in the amount of target control. In other words, the controller 140 may calculate a new opening compensation value and may repeatedly reflect the new opening compensation value into the amount of target control, such that a total opening compensation value, which is reflected into the amount of target control, becomes the predetermined maximum opening compensation value or less.

For example, when the tailgate control corresponding to the user input is the closing operation, the controller 140 may identify a latch motor operation signal during the closing operation. For example, the controller 140 may identify whether the latch motor operation signal is generated while the closing operation is performed, based on, for example, the operation history of the latch controller 160.

As an example, when identifying cinching of the latch is not performed during the closing operation, based on the latch motor operation signal, the controller 140 may determine that the second problem has occurred. In other words, when identifying that the latch motor operation signal is not generated at the end of the closing operation, the controller 140 may determine that tailgate lock processing through the cinching of the latch is not normally performed to determine that the second problem has occurred.

As an example, the controller 140 may identify a closing compensation value based on at least one of a first time point when a first switch (e.g., a pawl switch) included in the latch controller 160 is turned on, a second time point when a second switch (e.g., a reference switch) is turned on, a predetermined maximum closing compensation value (e.g., 1000 rpm), a compensation constant, or any combination thereof. For example, when a difference between the first time point and the second time point is less than or equal to a specified time, the controller 140 may identify a smaller value between a first value identified using the difference and the compensation constant and the predetermined maximum closing compensation value as the closing compensation value. For example, when the difference between the first time point and the second time point is greater than the specified time, the controller 140 may not reflect the closing compensation value into the amount of target control. In other words, when the difference is greater than the specified time, the controller 140 may determine that there is no need for compensation and may calculate the closing compensation value as “0”. For example, the specified time may be a time predefined by a user or a developer. For example, when the user input corresponding to the closing operation for the tailgate is received again, the controller 140 may perform the closing operation based on the amount of target control into which the closing compensation value has been reflected. At this time, when it is determined that the second problem has occurred again, the controller 140 may calculate a closing compensation value again in the above-mentioned manner. At this time, the controller 140 may identify the closing compensation value as the predetermined maximum closing compensation value or less and may reflect the closing compensation value in the amount of target control. In other words, the controller 140 may calculate a new closing compensation value and may repeatedly reflect the new opening compensation value into the amount of target control, such that a total closing compensation value which is reflected into the amount of target control becomes the predetermined maximum closing compensation value or less.

For example, the controller 140 may reflect the calculated compensation value into the amount of target control. As an example, when the first problem has occurred, the controller 140 may calculate an opening compensation value in the compensation value and may add the opening compensation value to an opening control parameter (e.g., an RPM to be used at a time point when the opening operation starts) in the amount of target control.

As an example, when the second problem has occurred, the controller 140 may calculate a closing compensation value in the compensation value and may subtract the closing compensation value from a closing control parameter (e.g., an RPM to be used at a time point when the opening operation ends) in the amount of target control.

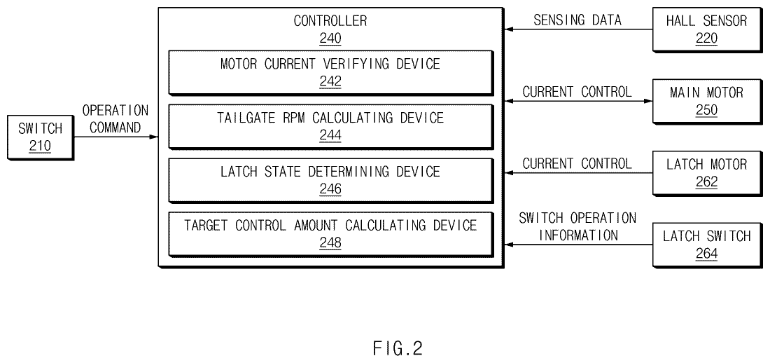

FIG. 2 is a conceptual diagram illustrating components and an operation of a vehicle control apparatus according to an embodiment of the present disclosure.

According to an embodiment, a vehicle control apparatus (e.g., a vehicle control apparatus 100 of FIG. 1) may include at least one of a switch 210 (e.g., an input device 110 of FIG. 1), a hall sensor 220 (e.g., a sensor device 120 of FIG. 1), a controller 240 (e.g., a controller 140 of FIG. 1), a main motor 250 (e.g., a tailgate driving device 150 of FIG. 1), a latch motor 262, a latch switch 264, or any combination thereof. For example, the latch motor 262 and the latch switch 264 may be components included in a latch controller 160 of FIG. 1. For example, the controller 240 may be operatively connected to at least one of the switch 210, the hall sensor 220, the main motor 250, the latch motor 262, or the latch switch 264, or any combination thereof.

The structure of the components shown in FIG. 2 is illustrative, and embodiments of the present disclosure are not limited thereto. For example, the vehicle control apparatus may further include a component (e.g., a notification device, a communication device, or an interface), which is not shown in FIG. 2. Furthermore, at least some of components (e.g., a motor current verifying device 242, a tailgate RPM calculating device 244, a latch state determining device 246, and a target control amount calculating device 248) shown as being included in the controller 240 may be implemented as separate devices independent of the controller 240.

For example, the controller 240 may control an operation of at least one of the switch 210, the hall sensor 220, the main motor 250, the latch motor 262, the latch switch 264, or any combination thereof.

As an example, the controller 240 may receive an operation command from the switch 210. The operation command may be, for example, a tailgate opening and closing command corresponding to a user input (e.g., a pressure input and/or a touch input) received from a user. The tailgate opening and closing command may include a control command generated to control the tailgate to open and close.

For example, the controller 240 may include the motor current verifying device 242, the tailgate RPM calculating device 244, the latch state determining device 246, and the target control amount calculating device 248.

As an example, when receiving the operation command from the switch 210, the controller 240 may identify an operation type (e.g., an opening operation or a closing operation for a tailgate) corresponding to the user input.

As an example, the controller 240 may identify an operating current of the main motor 250 provided to control opening and closing of the tailgate, using the motor current verifying device 242.

As an example, the controller 240 may calculate (or verify) an RPM while the tailgate moves in real time in real time, using the tailgate RPM calculating device 244. As an example, the controller 240 may verify an RPM in real time, using the tailgate RPM calculating device 244. The motor current identifying device 242 may verify an RPM of the main motor 250 during the opening operation or the closing operation for the tailgate, based on at least a portion of sensing data received from the hall sensor 220 and/or information received from the main motor 250.

As an example, the controller 240 may verify whether a latch is cinched, using the latch state determining device 246. For example, after performing the closing operation for the tailgate, the controller 240 may identify whether cinching in which the latch disposed in one area of the tailgate is locked by being coupled to one area in a host vehicle is performed at the end of the closing operation. For example, the controller 240 may identify whether the latch is cinched based on at least one of an amount of current control received from the latch motor 262, switch operation information received from the latch switch 264, or any combination thereof.

As an example, the controller 240 may calculate an amount of target control for driving the main motor 250 and/or the latch motor 262, using the target control amount calculating device 248. For example, as a problem occurs in the process of opening or closing the tailgate, when reflecting a compensation value into the amount of target control, the controller 240 may calculate an amount of updated target control using the target control amount calculating device 248.

For example, the controller 240 may receive (or obtain) sensing data by means of the hall sensor 220.

For example, when a command to operate (or open and close) the tailgate is received from the switch 210, the controller 240 may identify state information (e.g., an opening and closing degree or a current open state) of the tailgate using the hall sensor 220.

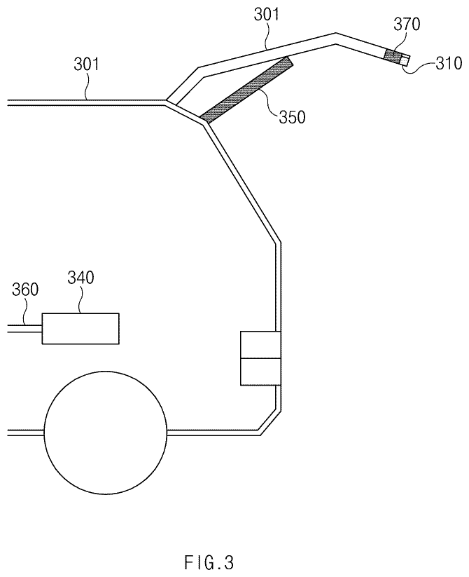

FIG. 3 is a conceptual diagram illustrating a host vehicle and a tailgate according to an embodiment of the present disclosure.

According to an embodiment, a vehicle control apparatus (e.g., a vehicle control apparatus 100 of FIG. 1) may control opening and closing of a tailgate 390, which covers the rear of a host vehicle 301.

For example, the vehicle control apparatus may include at least one of an input device 310 (e.g., an input device 110 of FIG. 1), a controller 340 (e.g., a controller 140 of FIG. 1), a driving device 350 (e.g., a tailgate driving device 150 of FIG. 1) for opening and closing the tailgate 390, a communication device 360, a latch 370, or any combination thereof.

Although not illustrated in FIG. 3, the vehicle control apparatus may further include a sensor device (e.g., a sensor device 120 of FIG. 1) configured to identify state information of the tailgate 390 (e.g., at least one of an opening and closing degree of the tailgate 390, whether the tailgate 390 moves, a movement direction of the tailgate 390, or any combination thereof).

For example, the vehicle control apparatus may receive a command to open and close the tailgate 390, which corresponds to a user input (e.g., a pressure input and/or a touch input), from a user through the input device 310.

For example, when receiving a user input through the input device 310 in a state in which the tailgate 390 is open as shown in FIG. 3, the vehicle control apparatus may identify an operation of opening and closing the tailgate 390, which corresponds to the user input, a closing operation because the tailgate 390 is open.

For example, when a command for the closing operation for the tailgate 390 is received, the vehicle control apparatus may close the tailgate 390 using the driving device 350. After the closing operation for the tailgate 390 is completed, the vehicle control apparatus may identify whether the latch 370 is normally cinched based on a latch motor operation signal obtained by means of a latch controller (e.g., the controller 340 or a latch controller 160 of FIG. 1). When it is identified that the latch 370 is not normally cinched, the vehicle control apparatus may identify a closing compensation value based on at least one of a first time point when a first switch (e.g., a pawl switch) included in the latch 370 (or the latch controller) is turned on, a second time point when a second switch (e.g., a reference switch) is turned on, a predetermined maximum closing compensation value (e.g., 1000 rpm), a compensation constant, or any combination thereof and may reflect the identified closing compensation value into an amount of target control for the closing operation.

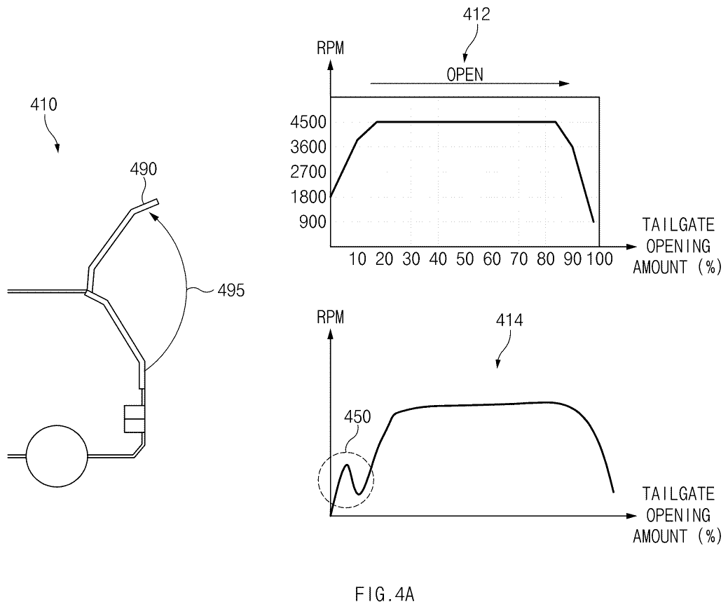

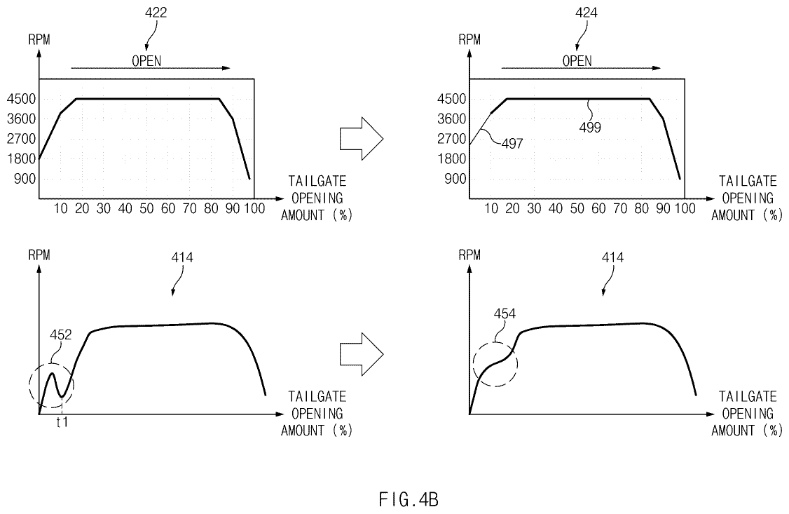

FIGS. 4A and 4B are operational conceptual diagrams of a vehicle control method according to an embodiment of the present disclosure.

Referring to reference numeral 410 of FIG. 4A, according to an embodiment, a vehicle control apparatus (e.g., a vehicle control apparatus 100 of FIG. 1) may identify various parameters (e.g., an amount of change in RPM) in a process of opening a tailgate 490 in a first direction 495 in a state in which the tailgate 490 is closed.

Reference numeral 412 of FIG. 4A may be a graph illustrating an amount of target control provided to control an opening operation.

According to an embodiment, the vehicle control apparatus may identify a tailgate opening amount according to the passage of time and an RPM value corresponding to the tailgate opening amount in the process of controlling the opening operation for the tailgate 490.

Referring to reference numeral 412 of FIG. 4A, according to the amount of target control for the opening operation, a required RPM at a time point when the opening operation starts may be about 1800 RPM, and a required RPM at a time point when the opening operation is completed may be about 900 RPM.

Reference numeral 414 of FIG. 4A may be a graph illustrating an amount of change in RPM, which is actually generated while the opening operation is controlled.

According to an embodiment, in the process of controlling the opening operation for the tailgate 490 based on the amount of target control according to reference numeral 412, the vehicle control apparatus may identify that the actually output RPM corresponds to a table of reference numeral 414.

Reference numeral 414 of FIG. 4A, according to the amount of control actually used, the vehicle control apparatus may identify an interval 450 where an inflection indicating that the RPM rapidly decreases and then increases occurs at an initial time point of the opening operation. Thus, the vehicle control apparatus may calculate an opening compensation value about the opening operation and may reflect the opening compensation value into the amount of target control as shown in a graph according to reference numeral 424 of FIG. 4B.

According to an embodiment, reference numeral 422 of FIG. 4B may indicate a graph according to a primary opening operation in which an inflection has occurred as an error between the amount of target control and an amount of actual control occurs as shown graphs according to reference numerals 412 and 414 of FIG. 4A.

According to an embodiment, reference numeral 424 of FIG. 4B, may indicate a graph in a process in which the vehicle control apparatus reflects the opening compensation value to update the amount of target control and performs a secondary opening operation again later. A first graph 497 may indicate a portion in which the amount of target control is updated. A second graph 499 may indicate a portion in which the RPM values are the same as each other in the primary opening operation and the secondary opening operation.

According to an embodiment, the vehicle control apparatus may identify a first time point t1 when a decreases stops and an increase starts in the interval in which the inflection has occurred (e.g., a time point when 700 ms elapse from a time point when the opening operation starts). For example, the vehicle control apparatus may identify an RPM magnitude (e.g., 700 RPM) actually used at the first time point t1. For example, when the actually used RPM magnitude is less than a predetermined maximum opening compensation value (e.g., 1000 RPM), the vehicle control apparatus may finally identify the actually used RPM magnitude as an opening compensation value.

According to an embodiment, as shown in the graph according to reference numeral 424, the vehicle control apparatus may reflect the identified opening compensation value in a start RPM of the opening operation. In other words, the vehicle control apparatus may add an opening compensation value (e.g., 700 RPM) to the start RPM (e.g., 1800 RPM) of the opening operation according to the amount of initial target control. As a result, it may be verified that the inflection does not occur or less occurs in a second interval 454 where the opening compensation value is added to the amount of target control to perform the opening operation, compared to a first interval 452 before the amount of target control is updated in the initial interval of the opening operation.

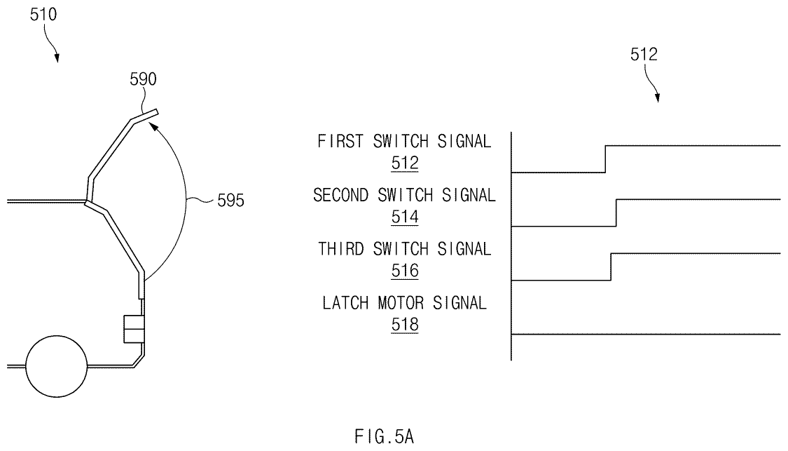

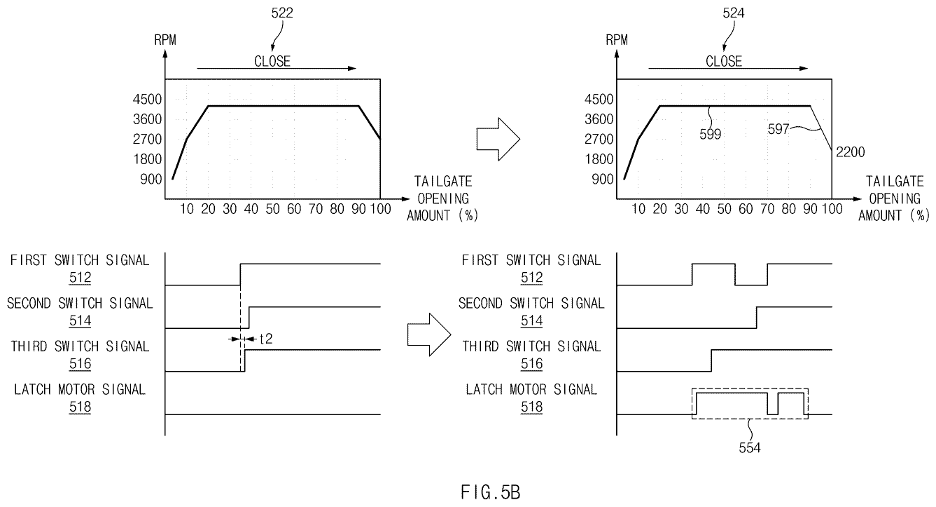

FIGS. 5A and 5B are operational conceptual diagrams of a vehicle control method according to an embodiment of the present disclosure.

Referring to reference numeral 510 of FIG. 5A, according to an embodiment, a vehicle control apparatus (e.g., a vehicle control apparatus 100 of FIG. 1) may identify various parameters (e.g., an amount of change in RPM) in a process of closing a tailgate 590 in a second direction 595 in a state in which the tailgate 590 is open.

Reference numeral 512 of FIG. 5A may be a graph illustrating a signal generated from at least one switch included in a latch and/or a latch motor at the end of the closing operation for the tailgate 590.

According to an embodiment, the vehicle control apparatus may identify a signal is generated from the at least one switch and/or the latch motor over time in the process of controlling the closing operation for the tailgate 590.

For example, a first switch signal 512 may be a signal generated from a first switch (e.g., a pawl switch) at the end of the closing operation.

For example, a second switch signal 514 may be a signal generated from a second switch (e.g., an ajar switch) at the end of the closing operation.

For example, a third switch signal 516 may be a signal generated from a third switch (e.g., a reference switch) at the end of the closing operation. For example, the third switch may be the reference switch which is turned on after a specified time elapses from a time point when the first switch is turned on.

For example, a latch motor signal 518 may be a signal generated from the latch motor at the end of the closing operation.

By means of the graph according to reference numeral 512, the vehicle control apparatus may identify that the latch motor signal 518 is not generated. Thus, the vehicle control apparatus may identify that a problem in which the cinching of the latch is not normally performed for the closing operation occurs. Thus, the vehicle control apparatus may calculate a closing compensation value about the closing operation and may reflect the closing compensation value into the amount of target control as shown in a graph according to reference numeral 524 of FIG. 5B.

According to an embodiment, reference numeral 522 of FIG. 5B may indicate a graph according to a primary closing operation in which the latch is not normally cinched at the end of the closing operation as shown in the graph according to reference numeral 512 of FIG. 5A. A first graph 597 may indicate a portion in which the amount of target control is updated. A second graph 599 may indicate a portion in which the RPM values are the same as each other in the primary closing operation and the secondary closing operation.

According to an embodiment, reference numeral 524 of FIG. 5B may indicate a graph in a process in which the vehicle control apparatus reflects the closing compensation value to update the amount of target control and performs the secondary closing operation again later.

According to an embodiment, as shown in the graph according to reference numeral 522, the vehicle control apparatus may identify a difference t2 between a time point when the first switch is turned on and a time point when the third switch is turned on, in the process of the primary closing operation in which the latch is not normally cinched. In this case, when the difference t2 is less than or equal to a specified time, the vehicle control apparatus may finally identify a smaller value among expected values identified based on a predetermined maximum closing compensation value (e.g., 1000 RPM) and the difference t2 as a closing compensation value. The expected value may be a value obtained by dividing a compensation constant K (e.g., 10000 RPM) by the difference t2. When the difference t2 is greater than the specified time, the vehicle control apparatus may set the closing compensation value to “0” and thus may not reflect any compensation into the amount of target control. In FIG. 5B, assuming that the expected value is 500 RPM and the predetermined maximum closing compensation value is 1000 RPM when t2 is 20 ms, the vehicle control apparatus may calculate 500 RPM as the final closing compensation value.

According to an embodiment, as shown in the graph according to reference numeral 524, the vehicle control apparatus may reflect the identified closing compensation value in an RPM at an end point of the closing operation. In other words, the vehicle control apparatus may add the closing compensation value (e.g., 500 RPM) in the RPM (e.g., 2700 RPM) at the end point of the closing operation according to the amount of initial target control. As a result, it may be verified that an on-signal that the latch motor operates is generated in one area 554 as a result of identifying the latch motor signal 518.

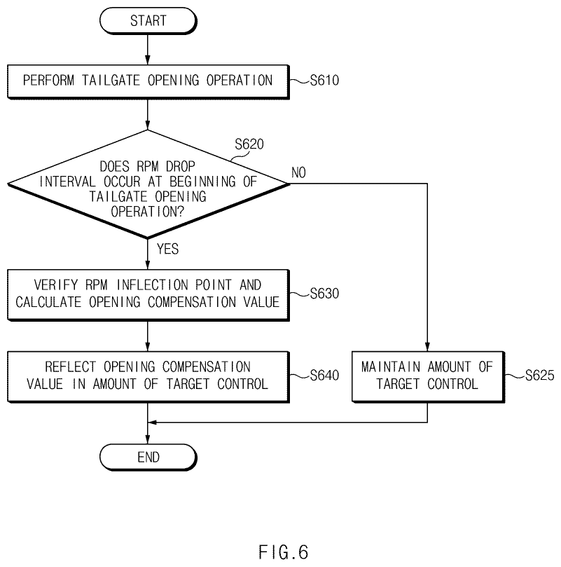

FIG. 6 is a flowchart of a vehicle control method according to an embodiment of the present disclosure.

According to an embodiment, a vehicle control apparatus (e.g., a vehicle control apparatus 100 of FIG. 1) may perform operations disclosed in FIG. 6. For example, at least some of components (e.g., an input device 110 of FIG. 1, a sensor device 120 of FIG. 1, a memory 130 of FIG. 1, a controller 140 of FIG. 1, a tailgate driving unit 150 of FIG. 1, a latch controller 160 of FIG. 1, or any combination thereof) included in the vehicle control apparatus may be configured to perform the operations of FIG. 6.

Operations in S610 to S640 in an embodiment below may be sequentially performed but are not necessarily sequentially performed. For example, an order of the respective operations may be changed, and at least two operations may be performed in parallel. Furthermore, contents, which correspond to or are duplicated with the contents described above in conjunction with FIG. 6, may be briefly described or omitted. The controller 140 of the vehicle control apparatus 100 may perform at least one operation in S610 to S640.

According to an embodiment, in S610, the vehicle control apparatus may perform a tailgate opening operation.

For example, when receiving a user input corresponding to the tailgate opening operation through an input device from a user, the vehicle control apparatus may open a tailgate using a tailgate driving device.

According to an embodiment, in S620, the vehicle control apparatus may identify whether an RPM drop interval occurs at the beginning of the tailgate opening operation.

For example, the vehicle control apparatus may identify whether an inflection interval in which the RPM rapidly decreases to a specified magnitude or more and then increases occurs at the beginning of the tailgate opening operation, after completing the tailgate opening operation (or in real time while controlling the tailgate opening operation). The vehicle control apparatus may identify an inflection point. Herein, the inflection point may be a point where a decrease stops and an increase starts.

For example, when the RPM drop interval occurs (e.g., S620—YES), the vehicle control apparatus may perform S630.

For example, when the RPM drop interval does not occur (e.g., S620—NO), the vehicle control apparatus may perform S625.

According to an embodiment, in S625, the vehicle control apparatus may maintain an amount of target control.

According to an embodiment, in S630, the vehicle control apparatus may verify an RPM inflection point and may calculate an opening compensation value.

For example, the vehicle control apparatus may identify an opening compensation value based on at least one of an RPM magnitude in the inflection, a time point when the inflection has occurred, a predetermined maximum opening compensation value, or any combination thereof.

For example, when the time point when the inflection has occurred is before a specified time point, the vehicle control apparatus may identify the RPM magnitude in the inflection as the opening compensation value.

For example, when the time point when the inflection has occurred is after the specified time point, the vehicle control apparatus may identify the predetermined maximum opening compensation value as the opening compensation value.

According to an embodiment, in S640, the vehicle control apparatus may reflect the opening compensation value into the amount of target control.

For example, the vehicle control apparatus may add the opening compensation value to an initial RPM value about the tailgate opening operation in the amount of target control.

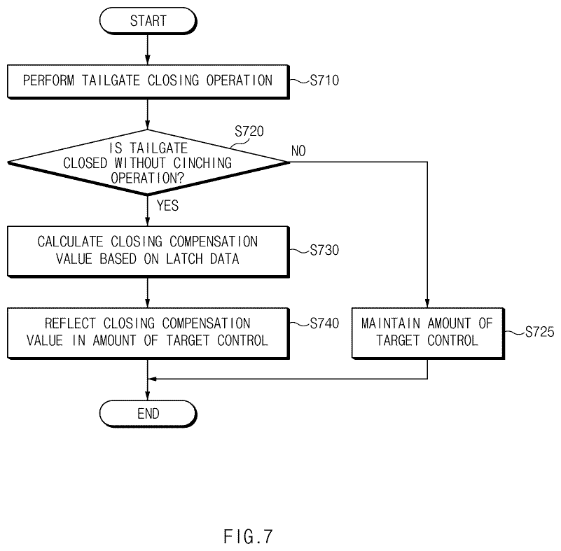

FIG. 7 is a flowchart of a vehicle control method according to an embodiment of the present disclosure.

According to an embodiment, a vehicle control apparatus (e.g., a vehicle control apparatus 100 of FIG. 1) may perform operations disclosed in FIG. 7. For example, at least some of components (e.g., an input device 110 of FIG. 1, a sensor device 120 of FIG. 1, a memory 130 of FIG. 1, a controller 140 of FIG. 1, a tailgate driving unit 150 of FIG. 1, a latch controller 160 of FIG. 1, or any combination thereof) included in the vehicle control apparatus may be configured to perform the operations of FIG. 7.

Operations in S710 to S740 in an embodiment below may be sequentially performed but are not necessarily sequentially performed. For example, an order of the respective operations may be changed, and at least two operations may be performed in parallel. Furthermore, contents, which correspond to or are duplicated with the contents described above in conjunction with FIG. 7, may be briefly described or omitted. The controller 140 of the vehicle control apparatus 100 may perform at least one operation in S710 to S740.

According to an embodiment, in S710, the vehicle control apparatus may perform a tailgate closing operation.

For example, when receiving a user input corresponding to the tailgate closing operation through an input device from a user, the vehicle control apparatus may close a tailgate using a tailgate driving device.

According to an embodiment, in S720, the vehicle control apparatus may identify whether the tailgate is closed without a cinching operation of a latch after the tailgate closing operation.

For example, the vehicle control apparatus may identify whether the cinching of the latch is not performed during the tailgate closing operation, based on an operation signal (e.g., a latch motor operation signal) received from a latch controller.

For example, when the tailgate is closed without the cinching operation of the latch (e.g., S720—YES), the vehicle control apparatus may perform S730.

For example, when the tailgate is not closed without the cinching operation of the latch (e.g., S720—NO), the vehicle control apparatus may perform S725.

According to an embodiment, in S725, the vehicle control apparatus may maintain an amount of target control.

According to an embodiment, in S730, the vehicle control apparatus may calculate a closing compensation value based on latch data.

For example, the vehicle control apparatus may identify the closing compensation value based on at least one of a first time point when a first switch included in the latch controller is turned on, a second time point when a second switch is turned on, a predetermined maximum closing compensation value, a compensation constant, or any combination thereof.

For example, when a difference between the first time point and the second time point is less than or equal to a specified time, the controller may identify a smaller value between a first value identified using the difference and the compensation constant and the predetermined maximum closing compensation value as the closing compensation value.

For example, when the difference between the first time point and the second time point is greater than the specified time, the vehicle control apparatus may identify the closing compensation value as “0” and may fail to inflect any compensation value in the amount of target control.

According to an embodiment, in S740, the vehicle control apparatus may reflect the closing compensation value into the amount of target control.

For example, the vehicle control apparatus may subtract the closing compensation value from an end RPM value about the tailgate closing operation in the amount of target control.

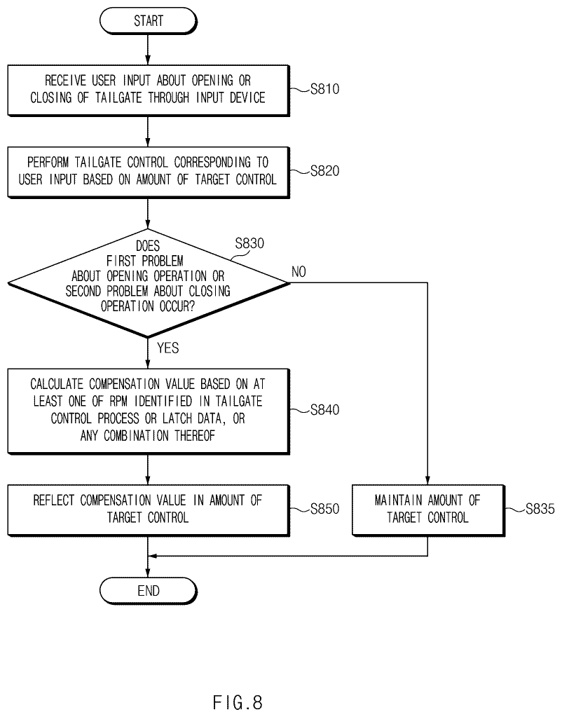

FIG. 8 is a flowchart of a vehicle control method according to an embodiment of the present disclosure.

According to an embodiment, a vehicle control apparatus (e.g., a vehicle control apparatus 100 of FIG. 1) may perform operations disclosed in FIG. 8. For example, at least some of components (e.g., an input device 110 of FIG. 1, a sensor device 120 of FIG. 1, a memory 130 of FIG. 1, a controller 140 of FIG. 1, a tailgate driving unit 150 of FIG. 1, a latch controller 160 of FIG. 1, or any combination thereof) included in the vehicle control apparatus may be configured to perform the operations of FIG. 8.

Operations in S810 to S850 in an embodiment below may be sequentially performed but are not necessarily sequentially performed. For example, an order of the respective operations may be changed, and at least two operations may be performed in parallel. Furthermore, contents, which correspond to or are duplicated with the contents described above in conjunction with FIG. 8, may be briefly described or omitted. The controller 140 of the vehicle control apparatus 100 may perform at least one operation in S810 to S850.

According to an embodiment, in S810, the vehicle control apparatus may receive a user input about opening or closing a tailgate through an input device.

According to an embodiment, in S820, the vehicle control apparatus may perform tailgate control corresponding to the user input based on an amount of target control.

According to an embodiment, in S830, the vehicle control apparatus may identify whether a first problem about an opening operation or a second problem about a closing operation occurs.

For example, when the first has occurred or the second problem has occurred (e.g., S830—YES), the vehicle control apparatus may perform S840.

For example, when the first problem or the second problem does not occur (e.g., S830—NO), the vehicle control apparatus may perform S835.

According to an embodiment, in S835, the vehicle control apparatus may maintain an amount of target control.

According to an embodiment, in S840, the vehicle control apparatus may calculate a compensation value based on at least one of an RPM identified in the tailgate control process, latch data, or any combination thereof.

According to an embodiment, in S850, the vehicle control apparatus may reflect the compensation value into the amount of target control.

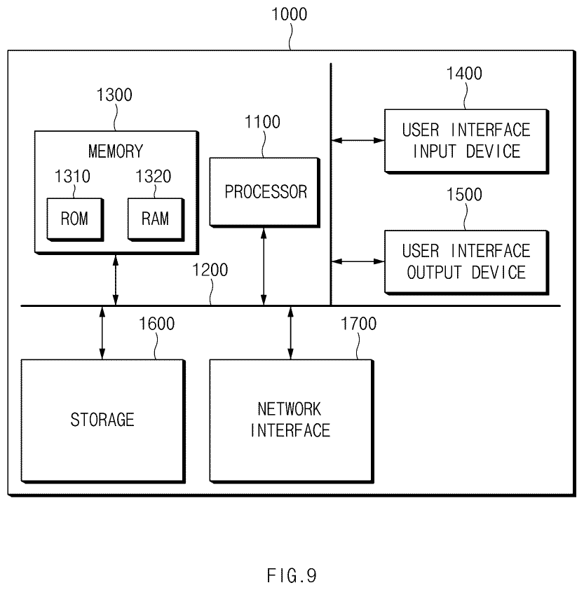

FIG. 9 illustrates a computing system about a vehicle control apparatus or a vehicle control method according to an embodiment of the present disclosure.

Referring to FIG. 9, a computing system 1000 about the vehicle control apparatus or the vehicle control method may include at least one processor 1100, a memory 1300, a user interface input device 1400, a user interface output device 1500, storage 1600, and a network interface 1700, which are connected to each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a read only memory (ROM) 1310 and a random access memory (RAM) 1320.

Accordingly, the operations of the method or algorithm described in connection with the embodiments disclosed in the specification may be directly implemented with a hardware module, a software module, or a combination of the hardware module and the software module, which is executed by the processor 1100. The software module may reside on a storage medium (that is, the memory 1300 and/or the storage 1600) such as a RAM, a flash memory, a ROM, an EPROM, an EEPROM, a register, a hard disc, a removable disk, and a CD-ROM.

The storage medium may be coupled to the processor 1100. The processor 1100 may read out information from the storage medium and may write information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

A description is given of effects of the vehicle control apparatus and the method thereof according to an embodiment of the present disclosure.

The vehicle control apparatus according to embodiments of the present disclosure may identify a problem, which occurs during an opening operation or a closing operation for the tailgate, when receiving a user input to open or close the tailgate from the user. The vehicle control apparatus may calculate a compensation value based on pieces of data identified during the operation when it is identified that the problem occurs. The vehicle control apparatus may reflect the calculated compensation value into an amount of target control to control an opening and closing operation using the amount of updated target control when the user input is received again later.

The vehicle control apparatus according to embodiments of the present disclosure may calculate an opening compensation value based on at least one of a time point when an inflection has occurred is before a specified time point, a predetermined maximum opening compensation value, an RPM magnitude in the inflection, or any combination thereof, when identifying that the inflection of the RPM occurs at a specified magnitude or more as a relatively large reaction force occurs at the beginning of the tailgate opening operation, after controlling the tailgate opening operation.

The vehicle control apparatus according to embodiments of the present disclosure may calculate a closing compensation value based on at least one of a first time point when a first switch included in a latch controller is turned on, a second time point when a second switch is turned on, a predetermined maximum closing compensation value, a compensation constant, or any combination thereof, when identifying that the cinching operation of the latch is not performed as a relatively small reaction force occurs at the end of the tailgate closing operation, after controlling the tailgate closing operation.

The vehicle control apparatus according to embodiments of the present disclosure may automatically calculate a compensation value according to a corresponding problem and may apply the calculated compensation value to an amount of target control upon next opening and closing control, when identifying that the problem occurs while continuously monitoring the process of opening and closing the tailgate, thus providing the user with a high-quality tailgate control function.

In addition, various effects ascertained directly or indirectly through the present disclosure may be provided.

Hereinabove, although the present disclosure has been described with reference to embodiments and the accompanying drawings, the present disclosure is not limited thereto. The present disclosure may be variously modified and altered by those having ordinary skill in the art to which the present disclosure pertains without departing from the spirit and scope of the present disclosure claimed in the following claims.

Therefore, embodiments of the present disclosure are not intended to limit the technical spirit of the present disclosure but provided only for the illustrative purpose. The scope of the present disclosure should be construed based on the accompanying claims, and all the technical ideas within the scope equivalent to the claims should be included in the scope of the present disclosure.

What is claimed is:

1. A vehicle control apparatus, comprising:
an input device;
a sensor device;
a memory configured to store at least one instruction; and
a controller operatively connected to the input device, the sensor device, and the memory,
wherein when executing the at least one instruction, the controller is configured to:
receive a user input about an opening operation or a closing operation for a tailgate through the input device;
perform tailgate control corresponding to the user input based on an amount of target control;
calculate a compensation value based on at least one of an amount of change in revolutions per minute (RPM) identified using the sensor device in a tailgate control process, latch data, or any combination thereof, when it is determined that a first problem about the opening operation or a second problem about the closing operation occurs; and
reflect the compensation value into the amount of target control.

2. The vehicle control apparatus of claim 1, wherein when executing the at least one instruction, the controller is further configured to:
identify the amount of change in RPM during the opening operation using the sensor device, when the tailgate control corresponding to the user input is the opening operation;
determine that the first problem has occurred when identifying an inflection indicating that the RPM decreases and then increases, based on the amount of change in RPM;
identify an opening compensation value based on at least one of an RPM magnitude in the inflection, a time point when the inflection has occurred, a predetermined maximum opening compensation value, or any combination; and
reflect the opening compensation value into the amount of target control.

3. The vehicle control apparatus of claim 2, wherein when executing the at least one instruction, the controller is further configured to:
identify the RPM magnitude in the inflection as the opening compensation value when the time point when the inflection has occurred is before a specified time point.

4. The vehicle control apparatus of claim 2, wherein when executing the at least one instruction, the controller is further configured to:
identify the predetermined maximum opening compensation value as the opening compensation value when the time point when the inflection has occurred is after a specified time point.

5. The vehicle control apparatus of claim 2, wherein when executing the at least one instruction, the controller is further configured to:
when the user input corresponding to the opening operation for the tailgate is received again, perform the opening operation based on the amount of target control to which the opening compensation value has been applied; and
identify the opening compensation value as the predetermined maximum opening compensation value or less; and
reflect the opening compensation value into the amount of target control, when it is determined that the first problem has occurred.

6. The vehicle control apparatus of claim 1, further comprising:
a latch controller,
wherein when executing the at least one instruction, the controller is further configured to:
when the tailgate control corresponding to the user input is the closing operation, identify a latch motor operation signal during the closing operation by the latch controller;
determine that the second problem has occurred, when identifying cinching of a latch is not performed during the closing operation, based on the latch motor operation signal;
identify a closing compensation value based on at least one of a first time point when a first switch included in the latch controller is turned on, a second time point when a second switch is turned on, a predetermined maximum closing compensation value, a compensation constant, or any combination; and
reflect the closing compensation value into the amount of target control.

7. The vehicle control apparatus of claim 6, wherein when executing the at least one instruction, the controller is further configured to:
identify a smaller value between a first value identified using a difference between the first time point and the second time point and the compensation constant and the predetermined maximum closing compensation value as the closing compensation value, when the difference between the first time point and the second time point is less than or equal to a specified time.

8. The vehicle control apparatus of claim 6, wherein when executing the at least one instruction, the controller is further configured to:
not reflect the closing compensation value into the amount of target control when a difference between the first time point and the second time point is greater than a specified time.

9. The vehicle control apparatus of claim 6, wherein when executing the at least one instruction, the controller is further configured to:
when the user input corresponding to the closing operation for the tailgate is received again, perform the closing operation based on the amount of target control into which the closing compensation value has been reflected; and
identify the closing compensation value as the predetermined maximum closing compensation value or less and reflect the closing compensation value into the amount of target control, when it is determined that the second problem has occurred while performing the closing operation.

10. The vehicle control apparatus of claim 1, wherein when executing the at least one instruction, the controller is further configured to:
when the first problem has occurred, calculate an opening compensation value in the compensation value and add the opening compensation value to an opening control parameter in the amount of target control; and
when the second problem has occurred, calculate a closing compensation value in the compensation value and subtract the closing compensation value from a closing control parameter in the amount of target control.

11. A vehicle control method, comprising:
receiving, by a controller, a user input about an opening operation or a closing operation for a tailgate through an input device;
performing, by the controller, tailgate control corresponding to the user input based on an amount of target control;
calculating, by the controller, a compensation value based on at least one of an amount of change in revolutions per minute (RPM) identified using a sensor device in a tailgate control process or latch data, or any combination thereof, when it is determined that a first problem about the opening operation or a second problem about the closing operation occurs; and
reflecting, by the controller, the compensation value into the amount of target control.

12. The vehicle control method of claim 11, further comprising:
identifying, by the controller, the amount of change in RPM during the opening operation using the sensor device, when the tailgate control corresponding to the user input is the opening operation;
determining, by the controller, the first problem has occurred when identifying an inflection indicating that an RPM decreases and then increases, based on the amount of change in RPM;
identifying, by the controller, an opening compensation value based on at least one of an RPM magnitude in the inflection, a time point when the inflection has occurred, a predetermined maximum opening compensation value, or any combination; and
reflecting, by the controller, the opening compensation value into the amount of target control.

13. The vehicle control method of claim 12, further comprising:
identifying, by the controller, the RPM magnitude in the inflection as the opening compensation value, when the time point when the inflection has occurred is before a specified time point.

14. The vehicle control method of claim 12, further comprising:
identifying, by the controller, the predetermined maximum opening compensation value as the opening compensation value, when the time point when the inflection has occurred is after a specified time point.

15. The vehicle control method of claim 12, further comprising:
when the user input corresponding to the opening operation for the tailgate is received again, performing, by the controller, the opening operation based on the amount of target control to which the opening compensation value has been applied; and
when it is determined that the first problem has occurred, identifying, by the controller, the opening compensation value as the predetermined maximum opening compensation value or less and reflect the opening compensation value into the amount of target control.

16. The vehicle control method of claim 11, further comprising:
when the tailgate control corresponding to the user input is the closing operation, identifying, by the controller, a latch motor operation signal during the closing operation by means of a latch controller;
when identifying cinching of a latch is not performed during the closing operation, determining, by the controller, that the second problem has occurred based on the latch motor operation signal;
identifying, by the controller, a closing compensation value based on at least one of a first time point when a first switch included in the latch controller is turned on, a second time point when a second switch is turned on, a predetermined maximum closing compensation value, a compensation constant, or any combination; and
reflecting, by the controller, the closing compensation value into the amount of target control.

17. The vehicle control method of claim 16, further comprising:
identifying, by the controller, a smaller value between a first value identified using a difference between the first time point and the second time point and the compensation constant and the predetermined maximum closing compensation value as the closing compensation value, when the difference between the first time point and the second time point is less than or equal to a specified time.

18. The vehicle control method of claim 16, further comprising:
not reflecting the closing compensation value into the amount of target control, when a difference between the first time point and the second time point is greater than a specified time.

19. The vehicle control method of claim 16, further comprising:
when the user input corresponding to the closing operation for the tailgate is received again, performing, by the controller, the closing operation based on the amount of target control into which the closing compensation value has been reflected; and
identifying, by the controller, the closing compensation value as the predetermined maximum closing compensation value or less and reflecting, by the controller, the closing compensation value into the amount of target control, when it is determined that the second problem has occurred while performing the closing operation.

20. The vehicle control method of claim 11, further comprising:
when the first problem has occurred, calculating, by the controller, an opening compensation value in the compensation value and adding, by the controller, the opening compensation value to an opening control parameter in the amount of target control; and
when the second problem has occurred, calculating, by the controller, a closing compensation value in the compensation value and subtracting, by the controller, the closing compensation value from a closing control parameter in the amount of target control.
